(19) United States
(12) Patent Application Publication
(10) Pub. No.: US 2021/0255645 A1
(43) Pub. Date: Aug. 19, 2021

(54) ONLINE MODELING METHOD FOR DYNAMIC MUTUAL OBSERVATION OF DRONE SWARM COLLABORATIVE NAVIGATION

(71) Applicant: NANJING UNIVERSITY OF AERONAUTICS AND ASTRONAUTICS, Nanjing, Jiangsu (CN)

(72) Inventors: Rong WANG, Nanjing, Jiangsu (CN); Zhi XIONG, Nanjing, Jiangsu (CN); Jianye LIU, Nanjing, Jiangsu (CN); Rongbing LI, Nanjing, Jiangsu (CN); Chuanyi LI, Nanjing, Jiangsu (CN); Junnan DU, Nanjing, Jiangsu (CN); Xin CHEN, Nanjing, Jiangsu (CN); Yao ZHAO, Nanjing, Jiangsu (CN); Yuchen CUI, Nanjing, Jiangsu (CN); Jingke AN, Nanjing, Jiangsu (CN); Tingyu NIE, Nanjing, Jiangsu (CN)

(21) Appl. No.: 17/274,445

(22) PCT Filed: Jul. 28, 2020
(86) PCT No.: PCT/CN2020/105037

§ 371 Date: Mar. 9, 2021

(30) Foreign Application Priority Data
Jul. 31, 2019 (CN) 201910699294.4

(51) Int. Cl. G05D 1/10; G08G 5/00; G01C 21/00; G01C 21/20

(52) U.S. Cl. CPC G05D 1/104; G08G 5/003; G01C 21/20; G01C 21/005; G08G 5/0008

(57) ABSTRACT

Disclosed is an online dynamic mutual-observation modeling method for unmanned aerial vehicle (UAV) swarm collaborative navigation, which includes: first performing first-level screening for members according to the number of usable satellites received by a satellite navigation receiver of each member, to determine the role of each member in collaborative navigation at the current time, and then establishing a moving coordinate system with each object member to be assisted as the origin, and calculating coordinates of each candidate reference node; and on this basis, performing second-level screening for the candidate reference nodes according to whether mutual distance measurement can be performed with each object member, to obtain a usable reference member set, and preliminarily establishing a dynamic mutual-observation model; and finally, optimizing the model by means of iterative correction, and conducting a new round of dynamic mutual-observation modeling according to an observation relationship in the UAV swarm, its own positioning performance, and role change in collaborative navigation, thus providing an accurate basis for effectively realizing UAV swarm collaborative navigation.

### BACKGROUND OF THE INVENTION

### Field of the Invention

The present invention relates to the field of unmanned aerial vehicle (UAV) swarm collaborative navigation technologies, and in particular, to an online dynamic mutual-observation modeling method for UAV swarm collaborative navigation.

### Description of Related Art

A UAV swarm, a new concept proposed at home and abroad in recent years, is an organization mode of multiple UAVs for three-dimensional spatial arrangement and mission assignment to adapt to mission requirements, which deals with the formation, maintenance, and reorganization of formation flying, and also the organization of flight missions; and can be dynamically adjusted according to external conditions and mission demands.

The conventional integrated navigation system model is mainly based on measurement information of a fixed reference coordinate system and fixed performance. However, the relative position and positioning performance of members in the UAV swarm are constantly changing during the flight, and the role of each member as an assisted object node or an assisting reference node in the swarm collaborative navigation is also constantly changing. Therefore, the conventional integrated cooperative model is unable to adapt to the requirements of UAV swarm collaborative navigation.

Therefore, research on a dynamic mutual-observation model and modeling method based on a moving reference coordinate system and in consideration of an observation relationship between members, their own positioning performance, and role change in collaborative navigation can efficiently realize adaptive model description of mutual-observation information during collaborative navigation, thus providing support for autonomous collaboration of the UAV swarm.

### SUMMARY OF THE INVENTION

### Technical Problem

The technical problem to be solved by the present invention is to provide an online dynamic mutual-observation modeling method for UAV swarm collaborative navigation, which considers an observation relationship between members, their own positioning performance, and role change in collaborative navigation in a moving reference coordinate system; and establishes and optimizes a dynamic mutual-observation model, thus providing an accurate basis for realizing collaborative navigation.

### Technical Solution

The present invention adopts the following technical solution to solve the foregoing technical problem:

An online dynamic mutual-observation modeling method for UAV swarm collaborative navigation is provided, including the following steps:

step 1: numbering members in the UAV swarm as 1, 2, . . . , n; performing first-level screening for the members according to the number of usable satellites received by an airborne satellite navigation receiver of each member at the current time, to determine the role of each member in collaborative navigation: setting members which receive less than 4 usable satellites as object members and recording a number set of the object members as A; and setting members which receive not less than 4 usable satellites as candidate reference members and recording a number set of the candidate reference members as B, where A, B⊂{1, 2, . . . , n};

step 2: acquiring an airborne navigation system indication position of an object member i and establishing a local east-north-up geographic coordinate system regarding the object member with the indication position as the origin, where i denotes the member number and i∈A;

step 3: acquiring an airborne navigation system indication position of a candidate reference member j and its positioning error covariance; and putting, after transformation, the airborne navigation system indication position of the candidate reference member j and its positioning error covariance into the local east-north-up geographic coordinate system regarding the object member i and established in step 2, where j denotes the member number and j∈B;

step 4: performing second-level screening for the candidate reference members according to whether each object member and each candidate reference member can measure the distance for each other, to determine the role of each candidate reference member in collaborative navigation: setting a candidate reference member for which mutual distance measurement can be performed with the object member i as a usable reference member for the object member i, and recording a number set of the usable reference members for the object member i as Cᵢ, where Cᵢ⊂B;

step 5: calculating a mutual-observation vector between the object member and its usable reference member, and calculating a vector projection matrix regarding the object member and its usable reference member according to the mutual-observation vector;

step 6: calculating an object position projection matrix and a usable reference position projection matrix regarding the object member and its usable reference member;

step 7: calculating a status mutual-observation matrix between the object member and its usable reference member by using the vector projection matrix obtained in step 5 and the object position projection matrix obtained in step 6;

step 8: calculating a noise mutual-observation matrix between the object member and its usable reference member by using the vector projection matrix obtained in step 5 and the usable reference position projection matrix obtained in step 6; and calculating a mutual-observation noise covariance between the object member and its usable reference member by using the noise mutual-observation matrix;

step 9: establishing a mutual-observation set matrix regarding the object member for all of its usable reference members by using the status mutual-observation matrix obtained in step 7;

step 10: establishing a mutual-observation set covariance regarding the object member for all of its usable reference members by using the mutual-observation noise covariance obtained in step 8;

step 11: establishing a mutual-observation set observed quantity regarding the object member for all of its usable reference members by using the mutual-observation vector obtained in step 5;

step 12: establishing a dynamic mutual-observation model for UAV swarm collaborative navigation according to the mutual-observation set matrix obtained in step 9, the mutual-observation set covariance obtained in step 10, and the mutual-observation set observed quantity obtained in step 11; performing weighted least squares positioning for the object member by using the dynamic mutual-observation model, to obtain a longitude correction, a latitude correction, and a height correction of the position of the object member; and calculating a corrected longitude, latitude, and height;

step 13: calculating position estimation covariance of the object member by using the status mutual-observation matrix obtained in step 7 and the mutual-observation noise covariance obtained in step 8;

step 14: calculating an online modeling error amount by using the object position projection matrix obtained in step 6 and the longitude correction, the latitude correction, and the height correction of the object member obtained in step 12; when the online modeling error amount is less than a preset error control standard of online dynamic mutual-observation modeling, determining that iterative convergence occurs in online modeling, that is, ending online modeling and going to step 15; otherwise, returning to step 5 to make iterative correction on the mutual-observation model; and step 15: determining whether navigation ends; if yes, ending the process; otherwise, returning to step 1 to conduct next-round modeling.

As a preferred solution of the present invention, the mutual-observation vector described in step 5 has the following expression:

$${r}_{k}^{i} = [ \begin{matrix}{x}_{k}^{i} \\ {y}_{k}^{i} \\ {z}_{k}^{i}\end{matrix} ] = [ \begin{matrix}- Δ {λ}_{ik} ( {R}_{N} + {h}_{i} ) cos {L}_{i} & \\ - Δ {L}_{ik} ( {R}_{N} + {h}_{i} ) + Δ {L}_{ik} {f}^{2} {cos}^{2} {L}_{i} & \\ - Δ {h}_{ik} + Δ {L}_{ik} {f}^{2} sin {L}_{i} cos {L}_{i} & \end{matrix} ]$$

where rₖⁱ denotes a mutual-observation vector between the object member i and its usable reference member k; xₖⁱ [symbol] yₖⁱ [symbol] zₖⁱ respectively denote east-direction, north-direction, and up-direction components of rₖⁱ in the local east-north-up geographic coordinate system regarding the object member i; Δλᵢₖ [symbol] ΔLᵢₖ [symbol] Δhᵢₖ denote difference values respectively in longitude, latitude, and height output by an airborne navigation system and between the object member i and its usable reference member k; R_{N} denotes the radius of curvature in prime vertical of the earth's reference ellipsoid; f denotes the oblateness of the earth's reference ellipsoid; and Lᵢ and hᵢ respectively denote the latitude and the height of the object member i output by the airborne navigation system.

As a preferred solution of the present invention, the vector projection matrix described in step 5 has the following expression:

$${M}_{k}^{i} = [ \frac{{x}_{k}^{i}}{{d}_{ik}} \frac{{y}_{k}^{i}}{{d}_{ik}} \frac{{z}_{k}^{i}}{{d}_{ik}} ]$$

where Mₖⁱ denotes a vector projection matrix regarding the object member i and its usable reference member k; xₖⁱ [symbol] yₖⁱ [symbol] zₖⁱ respectively denote east-direction, north-direction, and up-direction components of rₖⁱ in the local east-north-up geographic coordinate system regarding the object member i; rₖⁱ denotes the mutual-observation vector between the object member i and its usable reference member k; and dᵢₖ denotes a calculated value of a distance between the object member i and its usable reference member k, and has the following expression: dᵢₖ=\sqrt{xₖⁱ²+yₖⁱ²+zₖⁱ²}.

As a preferred solution of the present invention, the object position projection matrix described in step 6 has the following expression:

$${N}_{k}^{i} = [ \begin{matrix}- {Δλ}_{ik} ( {R}_{N} + {h}_{i} ) sin {L}_{i} & ( {R}_{N} + {h}_{i} ) cos {L}_{i} & {Δλ}_{ik} cos {L}_{i} \\ {R}_{N} + {h}_{i} & 0 & Δ {L}_{ik} \\ 0 & 0 & 1\end{matrix} ]$$

where Nₖⁱ denotes an object position projection matrix regarding the object member i and its usable reference member k; Δλᵢₖ [symbol] ΔLᵢₖ denote difference values respectively in longitude and latitude output by the airborne navigation system and between the object member i and its usable reference member k; Lᵢ and hᵢ respectively denote the latitude and the height of the object member i output by the airborne navigation system; and R_{N} denotes the radius of curvature in prime vertical of the earth's reference ellipsoid.

As a preferred solution of the present invention, the usable reference position projection matrix described in step 6 has the following expression:

$${L}_{k}^{i} = [ \begin{matrix}0 & - ( {R}_{N} + {h}_{i} ) cos {L}_{i} & 0 \\ - ( {R}_{N} + {h}_{i} ) & 0 & 0 \\ 0 & 0 & - 1\end{matrix} ]$$

where Lₖⁱ denotes a usable reference position projection matrix regarding the object member i and its usable reference member k; Lᵢ and hᵢ respectively denote the latitude and the height of the object member i output by the airborne navigation system; and R_{N} denotes the radius of curvature in prime vertical of the earth's reference ellipsoid.

As a preferred solution of the present invention, the status mutual-observation matrix described in step 7 has the following expression:

Hₖⁱ=MₖⁱNₖⁱ

where k denotes a status mutual-observation matrix between the object member i and its usable reference member k; Mₖⁱ denotes a vector projection matrix regarding the object member i and its usable reference member k; and Nₖⁱ denotes an object position projection matrix regarding the object member i and its usable reference member k.

As a preferred solution of the present invention, the noise mutual-observation matrix described in step 8 has the following expression:

Dₖⁱ=MₖⁱLₖⁱ

where Dₖⁱ denotes a noise mutual-observation matrix between the object member i and its usable reference member k; Mₖⁱ denotes a vector projection matrix regarding the object member i and its usable reference member k; and Lₖⁱ denotes a usable reference position projection matrix regarding the object member i and its usable reference member k.

As a preferred solution of the present invention, the mutual-observation noise covariance described in step 8 has the following expression:

Rₖⁱ=Dₖⁱσₚₖ²Dₖ^{iT}+σ_{RF}²

where Rₖⁱ denotes a mutual-observation noise covariance between the object member i and its usable reference member k; Dₖⁱ denotes a noise mutual-observation matrix between the object member i and its usable reference member k; σ_{RF}² denotes an error covariance of a relative distance measuring sensor, and σₚₖ²: denotes a positioning error covariance of the usable reference member k.

As a preferred solution of the present invention, the online modeling error amount described in step 14 has the following expression:

uₖⁱ|Nₖⁱ[δ\hat{λ}ᵢδ\hat{L}ᵢδĥᵢ]^{T}|

where uₖⁱ denotes an online modeling error amount regarding the object member i and its usable reference member k; Nₖⁱ denotes an object position projection matrix regarding the object member i and its usable reference member k; and δ\hat{λ}ᵢ [symbol] δ\hat{L}ᵢ [symbol] δĥᵢ respectively denote a longitude correction, a latitude correction, and a height correction of the position of the object member i.

### Advantageous Effect

By using the foregoing technical solution, the present invention achieves the following technical effects compared to the prior art:

1. The present invention considers dynamic changes of navigation performance of members in the UAV swarm during flight, and determines the roles of the members in collaborative navigation by means of dynamic screening, so that members with high positioning performance preferably assist those with low positioning performance, thus solving the problem of poor modeling adaptability in a role-fixed mode.

2. The present invention considers the difference in positioning performance between reference members, and improves the modeling precision by combining positioning errors of the reference members and a measurement error of a distance measuring sensor and further by introducing iterative weight.

3. The present invention has high flexibility, and adapts to UAV swarms of different sizes and a mutual-observation condition of different relative position relationships between the members.

### BRIEF DESCRIPTION OF THE DRAWINGS

FIG. 1 is a flowchart of an online dynamic mutual-observation modeling method for UAV swarm collaborative navigation in the present invention;

FIG. 2 is a curve chart of iterative modeling in a moving coordinate system regarding an object member and established by the method of the present invention;

FIG. 3 is a curve chart showing a position error during iterative modeling by the method of the present invention; and

FIG. 4 is a curve chart showing longitude, latitude, and height errors during iterative modeling by the method of the present invention.

### DETAILED DESCRIPTION OF THE INVENTION

The embodiments of the present invention are described in detail below, and examples of the described embodiments are shown in the accompanying drawings. The following embodiments described with reference to the accompanying drawings are exemplary and are only used to explain the present invention, but cannot be construed as limiting the present invention.

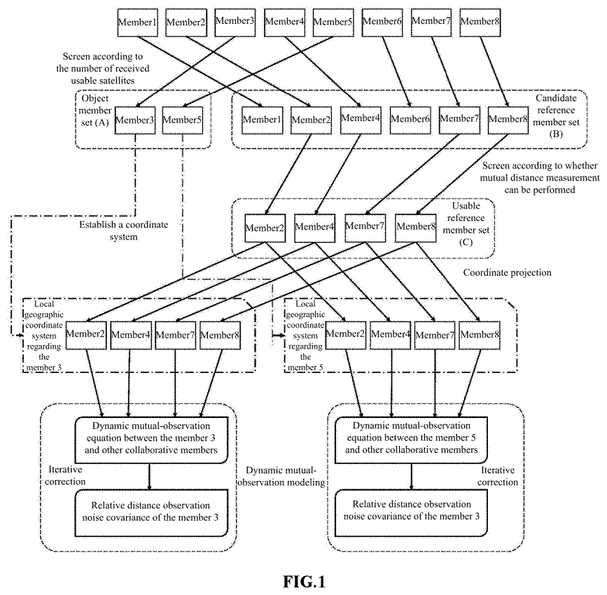

The present invention provides an online dynamic mutual-observation modeling method for UAV swarm collaborative navigation, which provides effective support for UAV swarm collaborative navigation and improves flexibility and precision of collaborative navigation modeling. A solution is shown in FIG. 1, and includes the following steps:

(1) The number of members in the UAV swarm is set to n and the members are sequentially numbered as 1, 2, . . . , n, where n is the number of all the members. An error control standard ζ of online dynamic mutual-observation modeling is set.

(2) First-level screening is performed for the members according to the number of usable satellites received by an airborne satellite navigation receiver of each member in the UAV swarm at the current time, to determine the role of each member in collaborative navigation: setting members which receive less than 4 usable satellites as object members and recording a number set of the object members as A; and setting members which receive not less than 4 usable satellites as candidate reference members and recording a number set of the candidate reference members as B, where A,B⊂{1, 2, . . . , n}.

(3) An airborne navigation system indication position of each object member in the classification in step (2) is acquired, and a local east-north-up geographic coordinate system regarding the object member is established with the indication position as the origin. The airborne navigation system indication position of an object member i is recorded as (λᵢ, Lᵢ, hᵢ) and a correspondingly established local east-north-up coordinate system is expressed as OᵢXYZ, where λ denotes the longitude, L denotes the latitude, h denotes the height, and denotes the member number and i∈A.

(4) An airborne navigation system indication position of each candidate reference member in the classification in step (2) and its positioning error covariance are acquired; and are put, after transformation, into the local east-north-up geographic coordinate system regarding the object member and established in step (3). The airborne navigation system indication position of a candidate reference member j is recorded as (λᵢ, Lᵢ, hᵢ), where j denotes the member number and j∈B.

(5) Second-level screening is performed for the candidate reference members successively according to whether each object member and each candidate reference member can measure the distance for each other, to determine the role of each candidate reference member in collaborative navigation: setting a candidate reference member for which mutual distance measurement can be performed with the object member i as a usable reference member for the object member and recording a number set of the usable reference members for the object member i as Cᵢ, where Cᵢ⊂B

(6) A mutual-observation vector between the object member and its usable reference member is calculated. The mutual-observation vector between the object member i and its usable reference member k is recorded as rₖⁱ which has the following expression:

$${r}_{k}^{i} = [ \begin{matrix}{x}_{k}^{i} \\ {y}_{k}^{i} \\ {z}_{k}^{i}\end{matrix} ] = [ \begin{matrix}- {Δλ}_{ik} ( {R}_{N} + {h}_{i} ) cos {L}_{i} \\ - Δ {L}_{ik} ( {R}_{N} + {h}_{i} ) + Δ {L}_{ik} {f}^{2} {cos}^{2} {L}_{i} \\ - Δ {h}_{ik} + Δ {L}_{ik} {f}^{2} sin {L}_{i} cos {L}_{i}\end{matrix} ]$$

where i and k are member numbers and i∈A, k∈Cᵢ; Δλᵢₖ, ΔLᵢₖ and Δhᵢₖ denote difference values respectively in longitude, latitude, and height output by an airborne navigation system and between the object member i and its usable reference member k; R_{N} denotes the radius of curvature in prime vertical of the earth's reference ellipsoid and is a constant; f denotes the oblateness of the earth's reference ellipsoid and is a constant; Lᵢ denotes the latitude of the object member i output by the airborne navigation system and hᵢ denotes the height of the object member i output by the airborne navigation system.

(7) A vector projection matrix is calculated by using the mutual-observation vector between the object member and its usable reference member obtained in step (6). A vector projection matrix regarding the object member i and its usable reference member k is recorded as MI which has the following expression:

$${M}_{k}^{i} = [ \frac{{x}_{k}^{i}}{{d}_{ik}} \frac{{y}_{k}^{i}}{{d}_{ik}} \frac{{z}_{k}^{i}}{{d}_{ik}} ]$$

where dᵢₖ denotes a calculated value of a distance between the object member i and its usable reference member k, and has the following expression: dᵢₖ=\sqrt{xₖⁱ²+yₖⁱ²+zₖⁱ²}.

(8) An object position projection matrix is calculated. The object position projection matrix regarding the object member i and its usable reference member k is recorded as Nₖⁱ which has the following expression:

$${N}_{k}^{i} = [ \begin{matrix}- {Δλ}_{ik} ( {R}_{N} + {h}_{i} ) sin {L}_{i} & ( {R}_{N} + {h}_{i} ) cos {L}_{i} & {Δλ}_{ik} cos {L}_{i} \\ {R}_{N} + {h}_{i} & 0 & Δ {L}_{ik} \\ 0 & 0 & 1\end{matrix} ]$$

(9) A usable reference position projection matrix is calculated. The usable reference position projection matrix regarding the object member i and its usable reference member k is recorded as Lₖⁱ which has the following expression:

$${L}_{k}^{i} = [ \begin{matrix}0 & - ( {R}_{N} + {h}_{i} ) cos {L}_{i} & 0 \\ - ( {R}_{N} + {h}_{i} ) & 0 & 0 \\ 0 & 0 & - 1\end{matrix} ]$$

(10) A status mutual-observation matrix between the object member and its usable reference member is calculated by using the vector projection matrix obtained in step (7) and the object position projection matrix obtained in step (8). The status mutual-observation matrix between the object member i and its usable reference member k is recorded as Hₖⁱ which has the following expression:

Hₖⁱ=MₖⁱNₖⁱ

(11) A noise mutual-observation matrix between the object member and its usable reference member is calculated by using the vector projection matrix obtained in step (7) and the usable reference position projection matrix obtained in step (9). The noise mutual-observation matrix between the object member i and its usable reference member k is recorded as A which has the following expression:

Dₖⁱ=MₖⁱLₖⁱ

(12) A mutual-observation noise covariance between the object member and its usable reference member is calculated by using the noise mutual-observation matrix obtained in step (11), which has the following expression:

Rₖⁱ=DₖⁱσₚₖⁱDₖ^{iT}+σ_{RF}²

where σ_{RF}ⁱ denotes an error covariance of a relative distance measuring sensor, and σₚₖ²: denotes a positioning error covariance of the usable reference member k.

(13) A mutual-observation set matrix regarding all the members in the UAV swarm is established by using the status mutual-observation matrix Hₖⁱ between the object member i and its usable reference member k obtained in step (10). The mutual-observation set matrix regarding the object member i for all of its usable reference members is recorded as Hₐₗₜⁱ which has the following expression:

$${H}_{all}^{i} = [ \begin{matrix}⋮ \\ {H}_{k}^{i} \\ ⋮\end{matrix} ] , k ∈ {C}_{i}$$

Hₐₗₜⁱ denotes a matrix composed of all Hₖⁱ serving as row vectors and meeting k∈Cᵢ.

(14) A mutual-observation set covariance regarding all members in the UAV swarm is established by using the mutual-observation noise covariance between the object member and its usable reference member obtained in step (12). The mutual-observation set covariance regarding the object member i for all of its usable reference members is recorded as Rₐₗₗⁱ which has the following expression:

$${R}_{all}^{i} = [ \begin{matrix}⋱ & & 0 \\ & {R}_{k}^{i} & \\ 0 & & ⋱\end{matrix} ] , k ∈ {C}_{i}$$

where Rₐₗₗⁱ denotes a matrix which is composed of all 14 serving as diagonal elements and meeting k∈Cᵢ and off-diagonal elements equal to 0.

(15) A mutual-observation set observed quantity regarding the members in the UAV swarm is established by using the mutual-observation vector between the object member and its usable reference member obtained in step (6). The mutual-observation set observed quantity regarding the object member i for all of its usable reference members is recorded as Yₐₗₗⁱ which has the following expression:

$${Y}_{all}^{i} = [ \begin{matrix}⋮ \\ {\tilde{d}}_{ik} - {d}_{ik} \\ ⋮\end{matrix} ] , k ∈ {C}_{i}$$

where dᵢₖ denotes a calculated value of a distance between the object member i and its usable reference member k, and has the following expression: dᵢₖ=\sqrt{xₖⁱ²+yₖⁱ²+zₖⁱ²}; \tilde{d}ᵢₖ; and \tilde{d}ᵢₖ denotes a measured value of the distance between the object member i and its usable reference member k.

(16) A dynamic mutual-observation model for UAV swarm collaborative navigation is created by using the mutual-observation set matrix Hₐₗₗⁱ regarding the object member i for all of its usable reference members obtained in step (13), the mutual-observation set covariance Rₐₗₗⁱ regarding the object member i for all of its usable reference members obtained in step (14), and the mutual-observation set observed quantity Yₐₗₗ^{i regarding the object member i for all of its usable reference members obtained in step (}15); and weighted least squares positioning is performed for the object member, to obtain a longitude correction δ\hat{λ}ᵢ, a latitude correction δ\hat{L}ᵢ, and a height correction δĥᵢ, of the position of the object member i.

(17) A corrected longitude, latitude, and height are calculated by using the longitude correction δ\hat{λ}ᵢ, the latitude correction δ\hat{L}ᵢ, and the height correction δĥᵢ, of the object member i, which have the following expression:

(\hat{λ}ᵢ,\hat{L}ᵢ,ĥᵢ)=(λᵢ+δ\hat{λ}ᵢ,Lᵢ+δ\hat{L}ᵢ,hᵢ+δĥᵢ)

(18) A position estimation covariance of the object member is calculated by using the status mutual-observation matrix between the object member and its usable reference member obtained in step (10) and the mutual-observation noise covariance between the object member and its usable reference member obtained in step (12). The position estimation covariance of the object member i is recorded as σₚᵢ which has the following expression:

$${σ}_{pi} = {\sum }_{k = 1}^{n} {H}_{k}^{iT} {R}_{k}^{i} {H}_{k}^{i}$$

(19) An online modeling error amount is calculated by using the object position projection matrix obtained in step (8) and the longitude correction δ\hat{λ}ᵢ, the latitude correction δ\hat{L}ᵢ, and the height correction δĥᵢ of the object member i obtained in step (16), which has the following expression:

uₖⁱ|Nₖⁱ[δ\hat{λ}ᵢδ\hat{L}ᵢδĥᵢ]^{T}|

(20) It is determined whether iterative convergence occurs in online modeling; and if uₖⁱ<ζ, it is determined that convergence occurs, and online modeling ends and step (21) is performed; otherwise, step (6) is performed to make iterative correction on the mutual-observation model.

(21) It is determined whether navigation ends; and if yes, the process ends; otherwise, step (2) is performed to conduct next-round modeling.

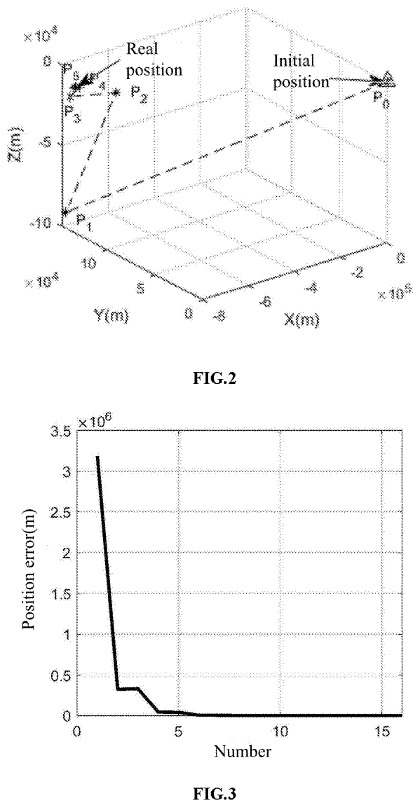

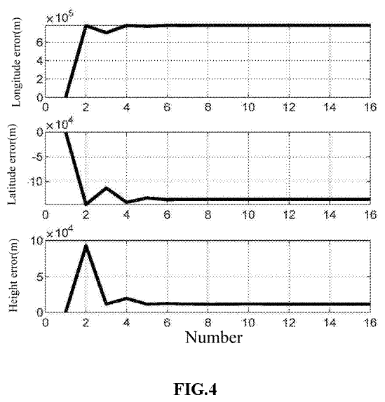

In order to verify the effectiveness of the UAV swarm collaborative navigation method under a dynamic observation condition proposed by the present invention, digital simulation and analysis are conducted. There are eight UAVs in the UAV swarm used in the simulation, and the measurement of a relative distance has a precision of 0.1 m. FIG. 1 is a scheme diagram of the dynamic mutual-observation modeling method for UAV swarm collaborative navigation in the present invention; FIG. 2 is a curve chart of iterative modeling in a moving coordinate system regarding an object member and established by the method of the present invention; FIG. 3 is a curve chart showing a position error during iterative modeling by the method of the present invention; and FIG. 4 is a curve chart showing longitude, latitude, and height errors during iterative modeling by the method of the present invention.

It can be learned from FIG. 2 that, after use of the mutual-observation model for UAV swarm collaborative navigation and the online modeling method provided by the present invention, a calculated position of an object member in the UAV swarm gradually converges from the initial position and approaches the real position. It can be learned from FIG. 3 that, after use of the mutual-observation model for UAV swarm collaborative navigation and the online modeling method provided by the present invention, the position error of the object member gradually reduces and a finally calculated position error is decreased by 4 orders of magnitude as compared with an initial error. It can be learned from FIG. 3 that, after use of the mutual-observation model for UAV swarm collaborative navigation and the online modeling method provided by the present invention, errors in the longitude, latitude, and height directions gradually reduce. In addition, the method of the present invention can adapt to the mutual-observation relationship and constant change of member roles during flight of the UAV swarm, thus achieving a desired application value.

The foregoing embodiment merely describes the technical idea of the present invention, but is not intended to limit the protection scope of the present invention. Any modification made based on the technical solutions according to the technical idea provided by the present invention falls within the protection scope of the present invention.

What is claimed is:

1. An online dynamic mutual-observation modeling method for unmanned aerial vehicle (UAV) swarm collaborative navigation, comprising the following steps:
step 1: numbering members in the UAV swarm as 1, 2, . . . , n; performing first-level screening for the members according to the number of usable satellites received by an airborne satellite navigation receiver of each member at the current time, to determine the role of each member in collaborative navigation: setting members which receive less than 4 usable satellites as object members and recording a number set of the object members as A; and setting members which receive not less than 4 usable satellites as candidate reference members and recording a number set of the candidate reference members as B, wherein A,B⊂{1, 2, . . . , n};
step 2: acquiring an airborne navigation system indication position of an object member i and establishing a local east-north-up geographic coordinate system regarding the object member with the indication position as the origin, wherein i denotes the member number and i∈A;
step 3: acquiring an airborne navigation system indication position of a candidate reference member j and its positioning error covariance; and putting, after transformation, the airborne navigation system indication position of the candidate reference member j and its positioning error covariance into the local east-north-up geographic coordinate system regarding the object member i and established in step 2, wherein j denotes the member number and j∈B;
step 4: performing second-level screening for the candidate reference members according to whether each object member and each candidate reference member are able to measure the distance for each other, to determine the role of each candidate reference member in collaborative navigation: setting a candidate reference member for which mutual distance measurement is able to be performed with the object member as a usable reference member for the object member i, and recording a number set of the usable reference members for the object member i as Cᵢ, wherein Cᵢ⊂B;
step 5: calculating a mutual-observation vector between the object member and its usable reference member, and calculating a vector projection matrix regarding the object member and its usable reference member according to the mutual-observation vector;
step 6: calculating an object position projection matrix and a usable reference position projection matrix regarding the object member and its usable reference member;
step 7: calculating a status mutual-observation matrix between the object member and its usable reference member by using the vector projection matrix obtained in step 5 and the object position projection matrix obtained in step 6;
step 8: calculating a noise mutual-observation matrix between the object member and its usable reference member by using the vector projection matrix obtained in step 5 and the usable reference position projection matrix obtained in step 6; and calculating a mutual-observation noise covariance between the object member and its usable reference member by using the noise mutual-observation matrix;
step 9: establishing a mutual-observation set matrix regarding the object member for all of its usable reference members by using the status mutual-observation matrix obtained in step 7;
step 10: establishing a mutual-observation set covariance regarding the object member for all of its usable reference members by using the mutual-observation noise covariance obtained in step 8;
step 11: establishing a mutual-observation set observed quantity regarding the object member for all of its usable reference members by using the mutual-observation vector obtained in step 5;
step 12: establishing a dynamic mutual-observation model for UAV swarm collaborative navigation according to the mutual-observation set matrix obtained in step 9, the mutual-observation set covariance obtained in step 10, and the mutual-observation set observed quantity obtained in step 11; performing weighted least squares positioning for the object member by using the dynamic mutual-observation model, to obtain a longitude correction, a latitude correction, and a height correction of the position of the object member; and calculating a corrected longitude, latitude, and height;
step 13: calculating position estimation covariance of the object member by using the status mutual-observation matrix obtained in step 7 and the mutual-observation noise covariance obtained in step 8;
step 14: calculating an online modeling error amount by using the object position projection matrix obtained in step 6 and the longitude correction, the latitude correction, and the height correction of the object member obtained in step 12; when the online modeling error amount is less than a preset error control standard of online dynamic mutual-observation modeling, determining that iterative convergence occurs in online modeling, that is, ending online modeling and going to step 15; otherwise, returning to step 5 to make iterative correction on the mutual-observation model; and
step 15: determining whether navigation ends; if yes, ending the process; otherwise, returning to step 1 to conduct next-round modeling.

2. The online dynamic mutual-observation modeling method for UAV swarm collaborative navigation according to claim 1, wherein the mutual-observation vector described in step 5 has the following expression:
$${r}_{k}^{i} = [ \begin{matrix}{x}_{k}^{i} \\ {y}_{k}^{i} \\ {z}_{k}^{i}\end{matrix} ] = [ \begin{matrix}- {Δλ}_{ik} ( {R}_{N} + {h}_{i} ) cos {L}_{i} \\ - Δ {L}_{ik} ( {R}_{N} + {h}_{i} ) + Δ {L}_{ik} {f}^{2} {cos}^{2} {L}_{i} \\ - Δ {h}_{ik} + Δ {L}_{ik} {f}^{2} sin {L}_{i} cos {L}_{i}\end{matrix} ]$$
wherein rₖⁱ denotes a mutual-observation vector between the object member i and its usable reference member k; xₖⁱ [symbol] yₖⁱ [symbol] zₖⁱ respectively denote east-direction, north-direction, and up-direction components of in the local east-north-up geographic coordinate system regarding the object member i;
Δλᵢₖ [symbol] ΔLᵢₖ [symbol] Δhᵢₖ denote difference values respectively in longitude, latitude, and height output by an airborne navigation system and between the object member i and its usable reference member k; R_{N} denotes the radius of curvature in prime vertical of the earth's reference ellipsoid; f denotes the oblateness of the earth's reference ellipsoid; and Lᵢ and hᵢ respectively denote the latitude and the height of the object member i output by the airborne navigation system.

3. The online dynamic mutual-observation modeling method for UAV swarm collaborative navigation according to claim 1, wherein the vector projection matrix described in step 5 has the following expression:
$${M}_{k}^{i} = [ \frac{{x}_{k}^{i}}{{d}_{ik}} \frac{{y}_{k}^{i}}{{d}_{ik}} \frac{{z}_{k}^{i}}{{d}_{ik}} ]$$
wherein Mₖⁱ denotes a vector projection matrix regarding the object member i and its usable reference member k; xₖⁱ [symbol] yₖⁱ [symbol] zₖⁱ respectively denote east-direction, north-direction, and up-direction components of rₖⁱ in the local east-north-up geographic coordinate system regarding the object member i; rₖⁱ denotes the mutual-observation vector between the object member i and its usable reference member k; and dᵢₖ denotes a calculated value of a distance between the object member i and its usable reference member k, and has the following expression: dᵢₖ=\sqrt{xₖⁱ²+yₖⁱ²+zₖⁱ²}.

4. The online dynamic mutual-observation modeling method for UAV swarm collaborative navigation according to claim 1, wherein the object position projection matrix described in step 6 has the following expression:
$${N}_{k}^{i} = [ \begin{matrix}- {Δλ}_{ik} ( {R}_{N} + {h}_{i} ) sin {L}_{i} & ( {R}_{N} + {h}_{i} ) cos {L}_{i} & {Δλ}_{ik} cos {L}_{i} \\ {R}_{N} + {h}_{i} & 0 & Δ {L}_{ik} \\ 0 & 0 & 1\end{matrix} ]$$
wherein Nₖⁱ (denotes an object position projection matrix regarding the object member i and its usable reference member k; Δλᵢₖ [symbol] ΔLᵢₖ denote difference values respectively in longitude and latitude output by the airborne navigation system and between the object member i and its usable reference member k; Lᵢ and hᵢ respectively denote the latitude and the height of the object member i output by the airborne navigation system; and R_{N} denotes the radius of curvature in prime vertical of the earth's reference ellipsoid.

5. The online dynamic mutual-observation modeling method for UAV swarm collaborative navigation according to claim 1, wherein the usable reference position projection matrix described in step 6 has the following expression:
$${L}_{k}^{i} = [ \begin{matrix}0 & - ( {R}_{N} + {h}_{i} ) cos {L}_{i} & 0 \\ - ( {R}_{N} + {h}_{i} ) & 0 & 0 \\ 0 & 0 & - 1\end{matrix} ]$$
wherein Lₖⁱ denotes a usable reference position projection matrix regarding the object member i and its usable reference member k; Lᵢ and hᵢ respectively denote the latitude and the height of the object member i output by the airborne navigation system; and R_{N} denotes the radius of curvature in prime vertical of the earth's reference ellipsoid.

6. The online dynamic mutual-observation modeling method for UAV swarm collaborative navigation according to claim 1, wherein the status mutual-observation matrix described in step 7 has the following expression:
Hₖⁱ=mₖⁱNₖⁱ
wherein Hₖⁱ denotes a status mutual-observation matrix between the object member i and its usable reference member k; Mₖⁱ denotes a vector projection matrix regarding the object member i and its usable reference member k; and Nₖⁱ denotes an object position projection matrix regarding the object member i and its usable reference member k.

7. The online dynamic mutual-observation modeling method for UAV swarm collaborative navigation according to claim 1, wherein the noise mutual-observation matrix described in step 8 has the following expression:
Dₖⁱ=MₖⁱLₖⁱ;
wherein Dₖⁱ denotes a noise mutual-observation matrix between the object member i and its usable reference member k; Mₖⁱ denotes a vector projection matrix regarding the object member i and its usable reference member k; and Lₖⁱ denotes a usable reference position projection matrix regarding the object member i and its usable reference member k.

8. The online dynamic mutual-observation modeling method for UAV swarm collaborative navigation according to claim 1, wherein the mutual-observation noise covariance described in step 8 has the following expression:
Rₖⁱ=Dₖⁱσₚₖ²Dₖ^{iT}+σ_{RF}²
wherein Rₖⁱ denotes a mutual-observation noise covariance between the object member i and its usable reference member k; Dₖⁱ denotes a noise mutual-observation matrix between the object member i and its usable reference member k; σ_{RF}² denotes an error covariance of a relative distance measuring sensor, and σₚₖ²: denotes a positioning error covariance of the usable reference member k.

9. The online dynamic mutual-observation modeling method for UAV swarm collaborative navigation according to claim 1, wherein the online modeling error amount described in step 14 has the following expression:
uₖⁱ|Nₖⁱ[δ\hat{λ}ᵢδ\hat{L}ᵢδĥᵢ]^{T}|

wherein uₖⁱ denotes an online modeling error amount regarding the object member i and its usable reference member k; Nₖⁱ denotes an object position projection matrix regarding the object member i and its usable reference member k; and δ\hat{λ}ᵢ [symbol] δ\hat{L}ᵢ [symbol] δĥᵢ respectively denote a longitude correction, a latitude correction, and a height correction of the position of the object member i.
